(19) United States
(12) Patent Application Publication
(10) Pub. No.: US 2019/0235062 A1
(43) Pub. Date: Aug. 1, 2019

(54) METHOD, DEVICE, AND STORAGE MEDIUM FOR LASER SCANNING DEVICE CALIBRATION

(71) Applicant: Tencent Technology (Shenzhen) Company Limited, Shenzhen (CN)

(72) Inventor: Chao ZENG, Shenzhen (CN)

(21) Appl. No.: 16/383,358

(22) Filed: Apr. 12, 2019

Related U.S. Application Data
(63) Continuation of application No. PCT/CN2018/087251, filed on May 17, 2018.

(30) Foreign Application Priority Data
Aug. 23, 2017 (CN) 201710731253.X

(51) Int. Cl. G01S 7/497; G01S 7/481; G01S 17/93; G01C 21/30

(52) U.S. Cl. CPC G01S 7/497; G01C 21/30; G01S 17/936; G01S 7/4817

(57) ABSTRACT

A method for calibrating a laser scanning device is performed at a computing device. After obtaining, based on at least two frames obtained by a laser scanning device, first coordinates of a surface feature element in each frame of point cloud data, the computing device determines, based on map data of the target region of a vehicle, second coordinates of the surface feature element in each frame of point cloud data in a vehicle coordinate system. For each frame of point cloud data, the computing device determines a pose offset of each frame of point cloud data according to the first and second coordinates of the surface feature element and calculates a value of a laser extrinsic parameter of the laser scanning device according to pose offsets of the at least two frames of point cloud data, to calibrate the laser scanning device.

### CROSS-REFERENCE TO RELATED APPLICATIONS

This application is a continuation application of PCT/CN2018/087251, entitled “LASER SCANNING DEVICE CALIBRATION METHOD, APPARATUS, DEVICE, AND STORAGE MEDIUM” filed on May 17, 2018, which claims priority to Chinese Patent Application No. 201710731253.X, entitled “METHOD AND APPARATUS FOR CALIBRATING LASER SCANNING DEVICE, DEVICE, AND STORAGE MEDIUM” filed with the Chinese Patent Office on Aug. 23, 2017, both of which are incorporated by reference in their entirety.

### FIELD OF THE TECHNOLOGY

This application relates to the field of driverless technologies, and in particular, to a method and an apparatus for calibrating a laser scanning device, a device, and a storage medium.

### BACKGROUND OF THE DISCLOSURE

With the development of driverless technologies, navigation systems in unmanned vehicles can provide navigation paths, so that the unmanned vehicles travel along the navigation paths. In addition, an unmanned vehicle may further scan the surrounding environment in real time by using a laser scanning device, to obtain a three-dimensional image of the surrounding environment, so that the unmanned vehicle can travel based on the surrounding environment and a navigation path, to escape obstacles in the surrounding environment, thereby ensuring driving safety. However, a laser coordinate system to which the three-dimensional image belongs and a vehicle coordinate system to which the navigation path belongs have a particular position offset and an angle offset. Therefore, before the laser scanning device is used, the laser scanning device further needs to be calibrated.

In the related art, a process of calibrating the laser scanning device is as follows: A marker is usually constructed in a calibration field, and a plurality of calibration points having obvious positions is disposed in the marker, thereby establishing the calibration field including the plurality of calibration points. In addition, a vehicle coordinate system using an unmanned vehicle as a coordinate origin is established in the calibration field, and coordinates of each calibration point in the vehicle coordinate system are manually measured in a conventional surveying and mapping manner. Then, a laser coordinate system using the laser scanning device as an origin is established, and the calibration field is scanned by using the laser scanning device, to obtain a frame of point cloud data, the frame of point cloud data including a set of surface points of the marker in the calibration field, and coordinates of each point in the set of surface points in the laser coordinate system. Based on the frame of point cloud data, a plurality of calibration points is manually selected from the set of surface points, to obtain coordinates of each calibration point in the laser coordinate system. According to the coordinates of each calibration point in the vehicle coordinate system and the coordinates of the calibration point in the laser coordinate system, a pose offset of the laser coordinate system relative to the vehicle coordinate system is calculated by using a singular value decomposition (SVD) algorithm, the pose offset including a value of an position offset and a value of a yaw angle of the laser coordinate system relative to the vehicle coordinate system, and the pose offset is directly used as a value of a laser extrinsic parameter of the laser scanning device. The yaw angle is an included angle between the x axis (the front direction of the laser scanning device) of the laser coordinate system and the x axis (the front direction of the unmanned vehicle) of the vehicle coordinate system. The laser scanning device is calibrated by using the value of the laser extrinsic parameter.

In the implementation process of the embodiments of this application, the inventors find that the related technology has at least the following problem:

In the foregoing method, the calibration field needs to be manually established, and subsequently, the coordinates of each calibration point in the vehicle coordinate system and the coordinates of each calibration point in the laser coordinate system can further be determined by using a manual measurement or identification method, leading to low efficiency of the method for calibrating the laser scanning device.

### SUMMARY

According to embodiments of this application, a method and an apparatus for calibrating a laser scanning device, a device, and a storage medium are provided.

According to a first aspect of this application, a method for calibrating a laser scanning device is performed at a computing device having one or more processors and memory storing a plurality of programs to be executed by the one or more processors, the method comprising:

obtaining, based on at least two frames of point cloud data obtained by a laser scanning device by scanning a target region, first coordinates of a surface feature element in each frame of point cloud data, the first coordinates being coordinates of the surface feature element in a laser coordinate system;

determining, based on map data of the target region, second coordinates of the surface feature element in each frame of point cloud data in a vehicle coordinate system;

determining, for each frame of point cloud data, a pose offset of each frame of point cloud data according to the first coordinates and the second coordinates of the surface feature element; and

calculating a value of a laser extrinsic parameter of the laser scanning device according to pose offsets of the at least two frames of point cloud data, to calibrate the laser scanning device.

According to a first aspect of this application, a computing device includes memory, one or more processors, and a plurality of computer readable instructions stored in the memory that, when executed by the one or more processors, cause the computing device to perform the aforementioned method for calibrating a laser scanning device.

A non-transitory computer readable storage medium storing a plurality of instructions for calibrating a laser scanning device in connection with a computing device having one or more processors, wherein the plurality of instructions, when executed by the one or more processors, cause the computing device to perform the aforementioned method for calibrating a laser scanning device.

Details of one or more embodiments of this application are provided in the following accompanying drawings and descriptions. Other features, objectives, and advantages of this application become more obvious with reference to the specification, the accompanying drawings, and the claims.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a schematic diagram of a driving system according to an embodiment of this application.

FIG. 2 is a flowchart of a method for calibrating a laser scanning device according to an embodiment of this application.

FIG. 3 is a schematic diagram of a preset scanning route according to an embodiment of this application.

FIG. 4 is a schematic diagram of a first distance according to an embodiment of this application.

FIG. 5 is a schematic diagram of a second distance according to an embodiment of this application.

FIG. 6 is a schematic structural diagram of an apparatus for calibrating a laser scanning device according to an embodiment of this application.

FIG. 7 is a schematic structural diagram of a computing device according to an embodiment of this application.

### DESCRIPTION OF EMBODIMENTS

The following clearly and completely describes the technical solutions in the embodiments of this application with reference to the accompanying drawings in the embodiments of this application. Apparently, the described embodiments are some embodiments of this application rather than all of the embodiments. All other embodiments obtained by persons skilled in the art based on the embodiments of this application without creative efforts shall fall within the protection scope of this application.

The embodiments of this application disclose a method for calibrating a laser scanning device. The laser scanning device may be any laser scanning device installed in a vehicle that requires navigation. For example, the laser scanning device may be installed in a vehicle such as an unmanned vehicle, an unmanned aerial vehicle, or a robot that requires navigation. This is not specifically limited in the embodiments of this application. The embodiments of this application are merely described by using a laser scanning device installed in a vehicle as an example.

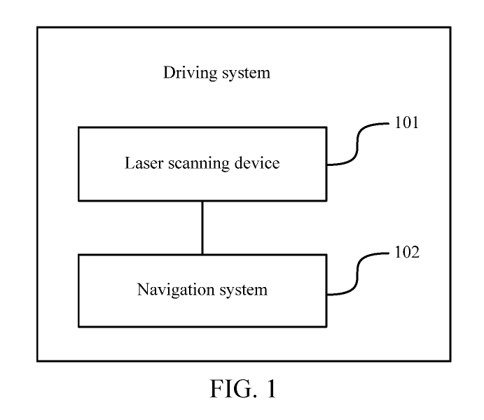

FIG. 1 is a schematic diagram of a driving system according to an embodiment of this application. The driving system includes a laser scanning device 101 and a navigation system 102.

The navigation system 102 prestores map data, the map data including at least position coordinates of each surface feature element in a target region in a map coordinate system. The navigation system 102 includes a Global Positioning System (GPS) and an inertial measurement unit (IMU). The navigation system 102 may receive a satellite signal by using the GPS, to locate current position coordinates of a vehicle in the map coordinate system. The navigation system 102 may determine a navigation path of the vehicle in the map data according to the current position coordinates of the vehicle and destination position coordinates of the vehicle, and convert path coordinates corresponding to the navigation path in the map coordinate system into coordinates in a vehicle coordinate system by using a geocentric coordinate system and a topocentric coordinate system, so that the vehicle travels along the navigation path in the vehicle coordinate system. In addition, the IMU integrates an accelerator and a gyroscope. In a traveling process of the vehicle, the navigation system 102 may further obtain a heading angle and a traveling speed of the vehicle in the vehicle coordinate system by using the IMU in real time, thereby monitoring a traveling status of the vehicle in real time.

The driving system further includes the laser scanning device 101. In the traveling process of the vehicle, the vehicle may further scan a surrounding environment by using the laser scanning device 101 in real time, to obtain a plurality of frames of point cloud data of the surrounding environment, each frame of point cloud data including position coordinates of each obstacle in the surrounding environment in a laser coordinate system, and the obstacle including, but not limited to, a fixed surface feature element, another moving vehicle and pedestrian, and the like in the surrounding environment; and convert, based on a laser extrinsic parameter of the laser scanning device 101, the position coordinates of each obstacle in the surrounding environment in the laser coordinate system into the coordinates in the vehicle coordinate system. The vehicle may travel based on the navigation path in the vehicle coordinate system and each obstacle in the surrounding environment, thereby ensuring driving safety of the vehicle.

The following describes appeared nouns about the driving system and some related coordinate systems, parameters, and the like.

The map data may be map data that is about a region for traveling and that is preset and prestored according to user requirements. Further, the map data may be high-precision map data. The high-precision map data is a next-generation navigation map with centimeter-level positioning precision and including information about subsidiary facilities of roads (such as traffic lights, electronic eyes, and traffic signs) and dynamic traffic information. Navigation can be more accurately performed by using the high-precision map data.

The vehicle may be an unmanned vehicle, and the unmanned vehicle obtains a navigation path by using the navigation system 102, and obtains a plurality of frames of point cloud data of the surrounding environment by using the laser scanning device 101, so that the unmanned vehicle can travel based on the navigation path in the vehicle coordinate system and each obstacle in the surrounding environment, thereby ensuring safe traveling of the unmanned vehicle.

The map coordinate system is usually a World Geodetic System for 1984 (WGS84), and position coordinates of each surface feature element is longitude and latitude coordinates and an elevation coordinate of the surface feature element in the WGS84 coordinate system.

The vehicle coordinate system uses the vehicle as a coordinate origin, uses a front direction in which the vehicle travels as a positive direction of the x axis, uses a horizontal-left direction perpendicular to the x axis as a positive direction of the y axis, and uses an upward vertical direction as a positive direction of the z axis.

The laser coordinate system is a coordinate system using the laser scanning device as a coordinate origin, using a front direction of the laser scanning device as a positive direction of the x axis, using a horizontal-left direction perpendicular to the x axis as a positive direction of the y axis, and using an upward vertical direction as a positive direction of the z axis.

The geocentric coordinate system is a space rectangular coordinate system established by using a center of mass of the Earth as a coordinate origin O, using an eastern direction of an intersection line of a first meridian plane and an equatorial plane as a positive direction of the x axis, using a northern of a rotational axis of the Earth as a positive direction of the z axis, and using a direction perpendicular to the xOz plane and determined according to the right hand rule as a positive direction of the y axis.

The topocentric coordinate system is a space rectangular coordinate system established by using topocentric coordinates as a coordinate system origin, using an eastern direction of a semi-major axis of the earth ellipsoid (east) as a positive direction of the x axis, using a northern direction of a semi-minor axis of the earth ellipsoid (north) as a positive direction of the y axis, and using an upward direction of a normal line of the earth ellipsoid (a direction to the sky) as a positive direction of the z axis.

The laser extrinsic parameter of the laser scanning device is an position offset and a yaw angle between the laser coordinate system and the vehicle coordinate system. The position offset is an offset distance, on the x axis and the y axis, of the laser coordinate system relative to the vehicle coordinate system. The yaw angle is an included angle between the x axis of the laser coordinate system and the x axis of the vehicle coordinate system, to be specific, an included angle between the front direction of the laser scanning device and the front direction in which the vehicle travels. In addition, this application further relates to a heading angle of the vehicle. The heading angle is an included angle between the front direction in which the vehicle travels and a direction of due north.

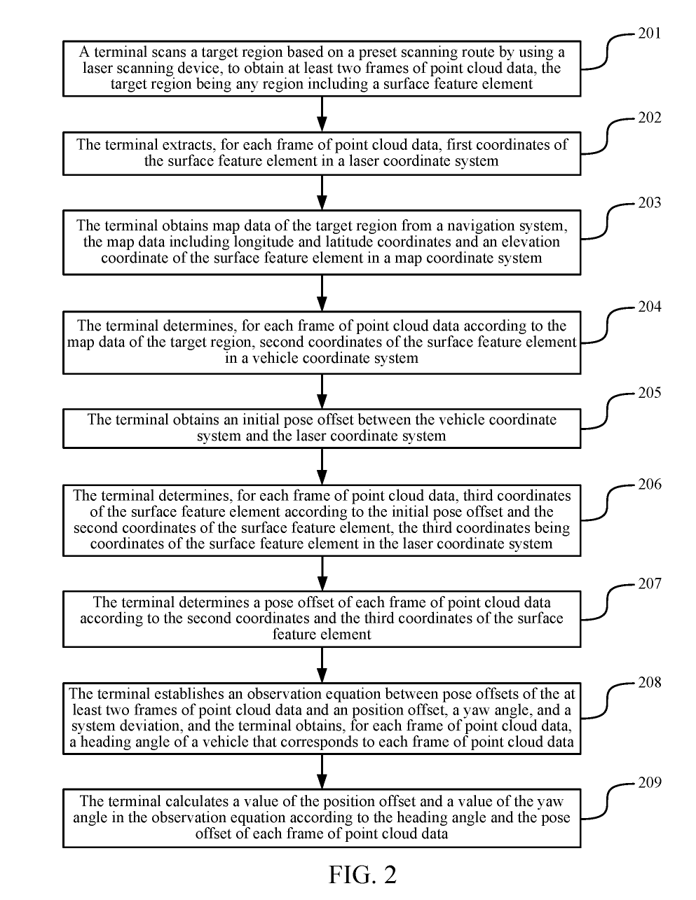

FIG. 2 is a flowchart of a method for calibrating a laser scanning device according to an embodiment of this application. The method is executed by a terminal, and the terminal may be an in-vehicle terminal or any terminal having a data processing function. Referring to FIG. 2, the method includes the following steps:

201. The terminal scans a target region based on a preset scanning route by using a laser scanning device, to obtain at least two frames of point cloud data, the target region being any region including a surface feature element.

The laser scanning device is installed in a vehicle, and may be disposed in front of or on a side of the vehicle to scan a surrounding environment of the vehicle. The preset scanning route may be a traveling route designed for scanning the target region.

In this embodiment of this application, this step may be: obtaining, by the terminal, the preset scanning route, and using the preset scanning route as a traveling route of the vehicle to control the vehicle to travel along the preset scanning route. In a process in which the vehicle travels along the preset scanning route, the terminal controls the laser scanning device to scan the target region at every interval of preset duration, to obtain a frame of point cloud data of the target region. In the entire traveling process, the terminal controls the laser scanning device to perform scanning at least twice, to obtain at least two frames of point cloud data of the target region. Each frame of point cloud data includes, but is not limited to, a set of surface points on each obstacle in the target region and position coordinates of each surface point in the laser coordinate system. The preset duration may be set and changed based on a user requirement. This is not specifically limited in this embodiment of this application. For example, the preset duration may be 100 milliseconds, 5 seconds, or the like.

The surface feature element includes but is not limited to a fixed curb, guardrail, rod-like feature, traffic sign, or the like in the target region. The surface feature element is an object having a fixed position in the target region. Therefore, using the surface feature element in the target region as a basic element of a calibration point, the laser scanning device may be finally calibrated by determining different coordinates of the surface feature element in the coordinate systems.

In this embodiment of this application, the target region may be any region including the surface feature element. To avoid ambient noise interference, the terminal may select a clear region having a few pedestrians as the target region. In a plurality of frames of point cloud data obtained by scanning the target region by the laser scanning device, there is less unnecessary noise data of other vehicles and the like, thereby reducing ambient noise interference, and improving accuracy of subsequently extracting first coordinates of the surface feature element based on the point cloud data.

In this embodiment of this application, the preset scanning route may be a scanning route determined based on the target region, and generally, the determined preset scanning route is a circular route surrounding the target region. The inventors recognized that in an actual operation, because a traveling direction of the vehicle in the traveling process may be any direction of north, south, east, west, and the like, the terminal may control the vehicle to travel along a circular path, thereby obtaining point cloud data of the target region on each traveling direction. In addition, when the vehicle travels, the vehicle needs to comply with traffic rules to travel on one side of the path, each frame of point cloud data collected by the terminal is point cloud data of a region on a left or right side. Therefore, the terminal may control the vehicle to travel along the circular path back and forth, that is, control the vehicle to travel along the circular path in a circle clockwise and then travel along the circular path in a circle counterclockwise, so that scanning can be performed when the vehicle travels on a left side of the path and on a right side of the path, thereby improving accuracy of subsequently determining a value of the laser extrinsic parameter according to a pose offset of each frame of point cloud data.

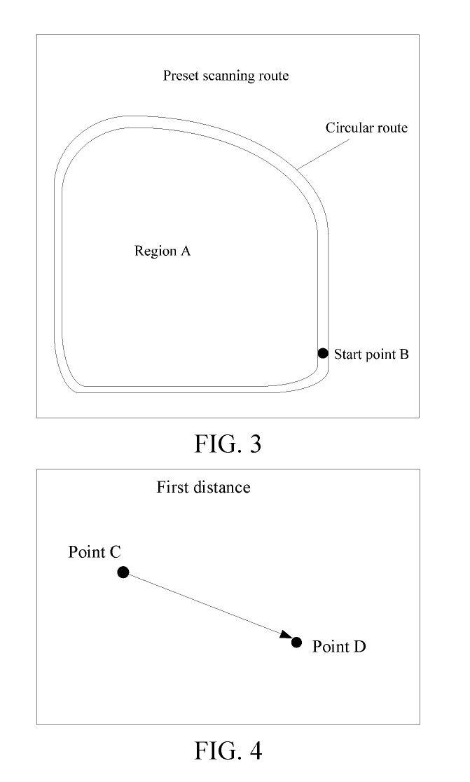

As shown in FIG. 3, the target region is a region A, and the preset scanning route may be a circular route surrounding the region A. That is, the terminal controls the vehicle to travel, from a start point B, along the circular path in a circle clockwise to back to the start point B, and then to travel, from the start point B, along the circular path in a circle counterclockwise.

202. The terminal extracts, for each frame of point cloud data, first coordinates of the surface feature element in a laser coordinate system.

In this embodiment of this application, because each frame of point cloud data includes the set of surface points on each obstacle in the target region and the position coordinates of each surface point in the laser coordinate system, the terminal further needs to extract the first coordinates of the surface feature element from each frame of point cloud data, the first coordinates being coordinates of the surface feature element in the laser coordinate system.

For each frame of point cloud data, the terminal extracts a point set corresponding to the surface feature element from the point cloud data by using a preset extraction algorithm. For each surface feature element, a position coordinates set, in the laser coordinate system, for a point set corresponding to the surface feature element is used as first coordinates of the surface feature element, to obtain first coordinates of the surface feature element included in each frame of point cloud data. The preset extraction algorithm may be set and changed based on a user requirement. This is not specifically limited in this embodiment of this application. For example, the preset extraction algorithm may be a segmentation-based extraction algorithm or a detection-based extraction algorithm.

It should be noted that step 201 and step 202 are actually a specific implementation of obtaining, by the terminal based on the at least two frames of point cloud data obtained by the laser scanning device by scanning the target region, the first coordinates of the surface feature element in each frame of point cloud data. However, the foregoing specific implementation may alternatively be replaced with another implementation, and the foregoing specific implementation is actually obtaining the point cloud data through real-time scanning. In an actual scenario, the at least two frames of point cloud data of the target region may alternatively be obtained from pre-scanned historical data. This is not specifically limited in this embodiment of this application.

203. The terminal obtains map data of the target region from a navigation system, the map data including longitude and latitude coordinates and an elevation coordinate of the surface feature element in a map coordinate system.

In this embodiment of this application, the navigation system of the vehicle stores the map data of the target region, and the terminal may obtain the map data of the target region from the navigation system according to region information of the target region. Certainly, the navigation system may further store map data of any region other than the target region, the map data actually is high-precision map data of the target region. Therefore, the map data of the target region includes at least position coordinates of the surface feature element in the target region in the map coordinate system. The region information may be a region identifier or latitude and longitude ranges of the target region. For example, the region identifier may be a name of the region.

In this embodiment of this application, the terminal needs to obtain a difference that is about the target region and that is between a vehicle coordinate system and the laser coordinate system. Therefore, after the terminal obtains the first coordinates of the surface feature element in the target region, the terminal further needs to obtain the position coordinates of the surface feature element in the map coordinate system, so that the terminal subsequently determines second coordinates of the surface feature element in the vehicle coordinate system.

The terminal may locate current position coordinates of the vehicle in the map coordinate system by using the navigation system. Therefore, when obtaining each frame of point cloud data, the terminal further needs to obtain the position coordinates of the surface feature element included in the frame of point cloud data in the map coordinate system by using the map data in the navigation system, and convert the position coordinates into the second coordinates in the vehicle coordinate system.

In a possible implementation, the region information may be a region identifier, and the terminal may store a correspondence between the region identifier and the map data. Correspondingly, the step of obtaining, by the terminal, the map data of the target region from the navigation system may be: obtaining, by the terminal, the region identifier of the target region, and obtaining, according to the region identifier of the target region, the map data corresponding to the target region from the correspondence between the region identifier and the map data.

In a possible implementation, the region information may be latitude and longitude ranges, and the terminal may store a correspondence between the latitude and longitude ranges and the map data. Correspondingly, the step of obtaining, by the terminal, the map data of the target region from the navigation system may be: obtaining, by the terminal, the latitude and longitude ranges of the target region, and obtaining, according to the latitude and longitude ranges of the target region, the map data corresponding to the target region from the correspondence between the latitude and longitude ranges and the map data.

204. The terminal determines, for each frame of point cloud data according to the map data of the target region, second coordinates of the surface feature element in a vehicle coordinate system.

In a vehicle traveling process, when the terminal obtains each frame of point cloud data, the vehicle coordinate system using the vehicle as an origin also moves with the vehicle. To determine second coordinates of a corresponding surface feature element in each frame of point cloud data in the vehicle coordinate system, when obtaining each frame of point cloud data, the terminal obtain, from the map data according to the surface feature element included in the frame of point cloud data, the longitude and latitude coordinates and the elevation coordinate of the surface feature element in the map coordinate system. The terminal determines, according to the longitude and latitude coordinates and the elevation coordinate of the surface feature element in the map coordinate system, the second coordinates of the surface feature element in the vehicle coordinate system.

Therefore, a process of determining, by the terminal according to the longitude and latitude coordinates and the elevation coordinate of the surface feature element in the map coordinate system, the second coordinates of the surface feature element in the vehicle coordinate system may be as follows: The terminal first converts the longitude and latitude coordinates and the elevation coordinate of the surface feature element in the map coordinate system into position coordinates in a geocentric coordinate system using a center of mass of the Earth as an origin, and then, converts the position coordinates of the surface feature element in the geocentric coordinate system into position coordinates in a topocentric coordinate system. The terminal obtains a heading angle of the vehicle by using an IMU of the navigation system, and converts the position coordinates of the surface feature element in the topocentric coordinate system into the second coordinates in the vehicle coordinate system according to the heading angle.

In this embodiment of this application, the coordinate origins of the topocentric coordinate system and the vehicle coordinate system are the same, but positive directions of the x axis and the y axis are different, an included angle between the positive direction of the x axis of the vehicle coordinate system and the positive direction of the y axis of the topocentric coordinate system is the heading angle of the vehicle. Therefore, the terminal may first convert the position coordinates of the surface feature element in the map coordinate system into the position coordinates in the topocentric coordinate system by using the geocentric coordinate system, and then finally obtain the second coordinates of the surface feature element according to the heading angle of the vehicle.

In this embodiment of this application, a system deviation exists in the map data obtained by using the navigation system, the system deviation being an offset deviation between the position coordinates of the surface feature element in the map data in the map coordinate system and actual position coordinates of the surface feature element in the map coordinate system. Therefore, to improve accuracy of determining the second coordinates, the terminal further needs to consider impact of the system deviation on the second coordinates. Specifically, a process of converting, by the terminal according to the heading angle, the position coordinates of the surface feature element in the topocentric coordinate system into the second coordinates in the vehicle coordinate system may be as follows: The terminal obtains an initial system deviation of the map data, and adjusts the position coordinates in the topocentric coordinate system according to the initial system deviation. The terminal converts, according to the heading angle, position coordinates obtained after the adjustment into the second coordinates in the vehicle coordinate system.

The process of adjusting the position coordinates of may be described as the following process: The initial system deviation may be represented by (x′₀,y′₀), that is, the terminal offsets the position coordinates of the surface feature element in the topocentric coordinate system by a distance of x′₀ units along the positive direction of the x axis and by a distance of y′₀ units along the positive direction of the y axis.

It should be noted that step 203 and step 204 are actually a specific implementation of determining, by the terminal based on the map data of the target region, the second coordinates of the surface feature element in each frame of point cloud data in the vehicle coordinate system. However, the foregoing specific implementation may alternatively be replaced with another implementation, and the foregoing specific implementation is actually obtaining the map data of the target region from the navigation system, to obtain the second coordinates. In an actual operation, the terminal may alternatively obtain the map data of the target region from the navigation system in advance, stores the map data of the target region in the terminal, and determines the second coordinates based on the map data of the target region that has been stored in the terminal. This is not specifically limited in this embodiment of this application.

In this embodiment of this application, the pose offset of each frame of point cloud data is a pose offset between the laser coordinate system and the vehicle coordinate system that exists when the terminal obtains each frame of point cloud data. As the vehicle moves, the laser coordinate system using the laser scanner as the coordinate origin and the vehicle coordinate system using the vehicle as the coordinate origin also move. In this case, the pose offsets of the frames of point cloud data may be the same or different. Therefore, the terminal further needs to determine the pose offset of each frame of point cloud data through the following step 205 to step 207.

205. The terminal obtains an initial pose offset between the vehicle coordinate system and the laser coordinate system.

In this embodiment of this application, the pose offset includes a value of an position offset and a value of a yaw angle between the vehicle coordinate system and the laser coordinate system. The position offset between the vehicle coordinate system and the laser coordinate system may be represented by position coordinates of the coordinate origin of the laser coordinate system in the vehicle coordinate system, and the yaw angle may be represented by an included angle between the x axis of the laser coordinate system and the x axis of the vehicle coordinate system.

In this embodiment of this application, first, an initial pose offset of each frame of point cloud data is determined through step 205, and then, a pose offset of each frame of point cloud data is determined through step 206 and step 207. The initial pose offset includes the value of the initial position offset and the value of the initial yaw angle.

In this step, the terminal may pre-obtain and prestore, through measurement, an initial pose offset between the vehicle coordinate system and the laser coordinate system, and use the initial pose offset as the initial pose offset of each frame of point cloud data. Specifically, the terminal may measure, by using measurement tools such as measuring tapes, coordinates of the laser scanning device in the vehicle coordinate system and the included angle between the x axis of the laser coordinate system and the x axis of the vehicle coordinate system, and uses the measured coordinates as the value of the initial position offset and the measured included angle as the value of the initial yaw angle.

206. The terminal determines, for each frame of point cloud data, third coordinates of the surface feature element according to the initial pose offset and the second coordinates of the surface feature element, the third coordinates being coordinates of the surface feature element in the laser coordinate system.

This step may be as follows: For each frame of point cloud data, the terminal performs position offsetting on the second coordinates of the surface feature element according to the value of the initial position offset in the initial pose offset of the frame of point cloud data, and performs, according to the value of the initial yaw angle in the initial pose offset of the frame of point cloud data, angle offsetting on the second coordinates that have undergone the position offsetting. The terminal uses position coordinates obtained after the position offsetting and the angle offsetting as the third coordinates of the surface feature element.

The value of the initial position offset may be represented by (dx“,dy′, and the initial yaw angle may be represented by dyaw”. That is, the terminal offsets the second coordinates of the surface feature element by a distance of dx″ units along the positive direction of the x axis and by a distance of dy″ units along the positive direction of the y axis, and rotates the offset second coordinates by dyaw″ unit angles counterclockwise.

207. The terminal determines a pose offset of each frame of point cloud data according to the first coordinates and the third coordinates of the surface feature element.

In this embodiment of this application, because each frame of point cloud data corresponds to one pose offset, the terminal may first determine, through step 207, a pose offset corresponding to each frame of point cloud data, so as to subsequently determine, according to pose offsets corresponding to a plurality of frames of point cloud data, a pose offset that can reflect a general rule.

This step may be implemented by using the following step 2071 and step 2072.

2071. The terminal calculates a first distance between each first dotted element and a neighboring second dotted element and a second distance between each first dotted element and a neighboring linear element according to the first coordinates and the third coordinates of the surface feature element.

In this embodiment of this application, in each frame of point cloud data, each surface feature element includes dotted elements and a linear element. The first dotted element is a dotted element in a surface feature element corresponding to the first coordinates, the second dotted element is a dotted element in a surface feature element corresponding to the third coordinates, and the linear element is a linear element in the surface feature element corresponding to the third coordinates.

For each frame of point cloud data, a distance between the first dotted element and a neighboring element can be calculated in any one of the following manners.

Manner 1: The first distance between the first dotted element and the second dotted element in the surface feature element of each frame of point cloud data is calculated as a reference distance for subsequent matching the first coordinates and the third coordinates.

In this step, the terminal calculates, according to position coordinates of each first dotted element in the laser coordinate system and position coordinates of a second dotted element neighboring to the first dotted elements in the laser coordinate system, a first distance between the first dotted element and the second dotted element.

It should be noted that, the second dotted element neighboring to the first dotted element is a second dotted element that is in a plurality of second dotted elements using the first dotted element as a center and that is nearest to the first dotted element.

As shown in FIG. 4, a point C is the first dotted elements, a point D is the second dotted element neighboring to the point C, and the terminal may calculate the first distance between the point C and the point D.

Manner 2: The second distance between the first dotted element and the linear element in the surface feature element of each frame of point cloud data is calculated as a reference distance for subsequent matching the first coordinates and the third coordinates.

The second distance between the first dotted element and the neighboring linear element is a normal distance from the first dotted element to the linear element. Therefore, in this step, the terminal calculates, according to position coordinates of each first dotted element in the laser coordinate system and position coordinates of a linear element neighboring to the first dotted element in the laser coordinate system, a normal distance between the first dotted element and the linear element, and uses the normal distance as the second distance.

It should be noted that, the linear element neighboring to the first dotted element is a linear element that is in a plurality of linear elements using the first dotted element as a center and that is nearest to the first dotted element.

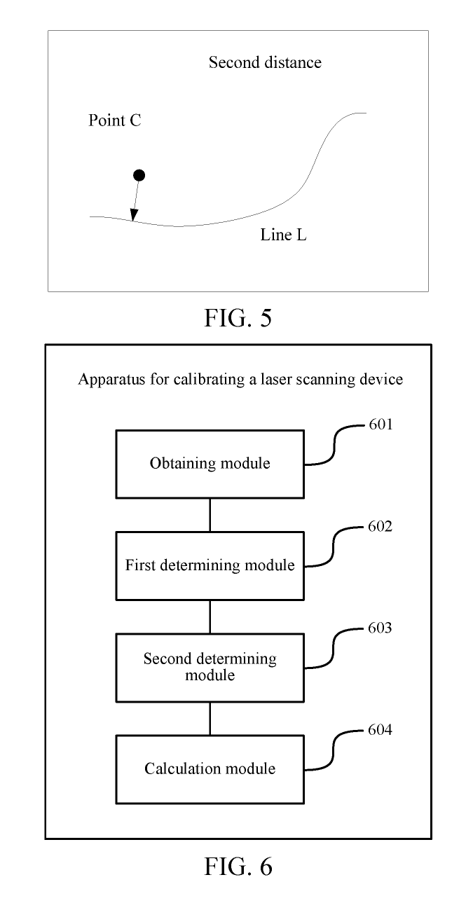

As shown in FIG. 5, a point C is the first dotted elements, a line L is the linear element neighboring to the point C, and the terminal may calculate the normal distance between the point C and the line L, so as to obtain the second distance.

In this step, the terminal uses position coordinates of a plurality of first dotted elements and position coordinates of a plurality of second dotted elements, to determine a plurality of first distances, and uses the position coordinates of the plurality of first dotted elements and position coordinates of a plurality of linear elements to determine a plurality of second distance.

2072. The terminal determines the pose offset of each frame of point cloud data according to the first distance and the second distance.

In this embodiment of this application, the terminal may perform a plurality of times of iterative matching on the first coordinates and the third coordinates of the surface feature element, to determine the pose offset of each frame of point cloud data.

A process thereof includes the following step a to step g:

Step a: For each frame of point cloud data, according to the first distance and the second distance, the terminal selects a first dotted element for which the first distance is less than a first preset threshold and a second dotted element corresponding to the first dotted element, and selects a first dotted element for which the second distance is less than the first preset threshold and a linear element corresponding to the first dotted element.

The second dotted element corresponding to the first dotted element is a second dotted element neighboring to the first dotted element when the terminal calculates the first distance. The linear element corresponding to the first dotted element is a linear element neighboring to the first dotted element when the terminal calculates the second distance.

Step b: The terminal determines, according to the selected first dotted element and second dotted element and the selected first dotted element and linear element and based on an expression of a mean square error between the first coordinates and the third coordinates, an offset matrix that enables a value of the mean square error to be minimum, and uses, the offset matrix that enables the value of the mean square error to be minimum as an intermediate offset matrix of the first coordinates and the third coordinates.

Step c: The terminal updates an initial offset matrix of the frame of point cloud data according to the intermediate offset matrix of the first coordinates and the third coordinates, and multiplies an updated initial offset matrix by the second coordinates to obtain fourth coordinates, thereby completing the first time of iterative matching.

The step of updating, by the terminal, an initial offset matrix of the frame of point cloud data according to the intermediate offset matrix of the first coordinates and the third coordinates may be: multiplying, by the terminal, the intermediate offset matrix of the first coordinates and the third coordinates by the initial offset matrix of the frame of point cloud data, to obtain the updated initial offset matrix.

It should be noted that the foregoing step c is actually a process of converting the second coordinates in the vehicle coordinate system back into coordinates in the laser coordinate system. An implementation thereof is the same as that in step 206, and details are not described herein again.

Step d: The terminal calculates a third distance between each first dotted element and a neighboring second dotted element and a fourth distance between each first dotted element and a neighboring linear element according to the first coordinates and the fourth coordinates of the surface feature element.

The step d is actually a process of re-calculating the first distance and the second distance according to the first coordinates and the fourth coordinates in the laser coordinate system that are obtained through the second time of conversion. An implementation thereof is the same as step 2071, and details are not described herein again.

Step e: Determine, through the implementations in step a to step c, an initial offset matrix obtained after the second time of update, thereby completing the second time of iterative matching.

Step f: Complete a plurality of times of iterative matching through the implementations in step a to step e. In a process of the plurality of iterations, when a minimum value of the mean square error corresponding to the intermediate offset matrix is less than a second preset threshold, an initial offset matrix updated according to the intermediate offset matrix is obtained, and the obtained initial offset matrix is used as the offset matrix of the frame of point cloud data. Alternatively, when a quantity of times of iterative matching reaches a third preset threshold, an initial offset matrix updated in a process of the last time of iterative matching is obtained, and the obtained initial offset matrix is used as the offset matrix of the frame of point cloud data.

Step g: The terminal determines the pose offset of the frame of point cloud data according to the offset matrix of the frame of point cloud data.

Step b may be specifically as follows: The terminal uses the offset matrix enabling the value of the mean square error to be minimum as the intermediate offset matrix of the first coordinates and the third coordinates by using the following formula 1, that is, the expression of the mean square error, according to the selected first dotted element and the second dotted element corresponding to the first dotted element, and selected the first dotted element and the linear element corresponding to the first dotted element:

$$E ( X , Y ) = {\sum }_{i = 1}^{m} {( {Mx}_{i} - {y}_{i} )}^{2} \qquad formula 1$$

X being the first coordinates of the surface feature element, Y being the third coordinates of the surface feature element, E(X,Y) being the mean square error between the first coordinates and the third coordinates of the surface feature element, xᵢ being an i^{th} first dotted element in the plurality of first dotted element and for which the first distance or the second distance is not greater than a preset threshold, yᵢ being a second dotted element or a linear element corresponding to the i^{th} first dotted element, m being a quantity of the first dotted elements for which the first distance or the second distance is not greater than the preset threshold, and M being the intermediate offset matrix of the first coordinates and the third coordinates.

In this embodiment of this application, the intermediate offset matrix of the first coordinates and the third coordinates may be represented by M, and

$${M}_{=} [ \begin{matrix}cos ( {dyaw}^{′} ) & - sin ( {dyaw}^{′} ) & {dx}^{′} \\ sin ( {dyaw}^{′} ) & cos ( {dyaw}^{′} ) & {dy}^{′} \\ 0 & 0 & 1\end{matrix} ] .$$

The intermediate offset matrix includes the value (dx′, dy′) of the position offset between the first coordinates and the third coordinates and the value of dyaw′ the yaw angle.

The first preset threshold, the second preset threshold, and the third preset threshold may be set and changed according to a user requirement. This is not specifically limited in this embodiment of this application. For example, the first preset threshold may be 1 m, 0.5 m, or the like, the second preset threshold may be 0.1 m, 0.3 m, or the like, and the third preset threshold may be 20 m, 100 m, or the like.

It should be noted that step 205 to step 207 are actually a specific implementation of determining, by the terminal for each frame of point cloud data, a pose offset of each frame of point cloud data according to the first coordinates and the second coordinates of the surface feature element. However, the foregoing specific implementation may alternatively be replaced with another implementation, and the foregoing specific implementation is actually converting the second coordinates in the vehicle coordinate system into the coordinates in the laser coordinate system, and determining the pose offset of each frame of point cloud data according to the first coordinates and the third coordinates obtained after the conversion. In an actual operation, the terminal may further convert the first coordinates in the laser coordinate system into the coordinates in the vehicle coordinate system to obtain the fourth coordinates obtained after the conversion, and determine the pose offset of each frame of point cloud data according to the second coordinates and the fourth coordinates obtained after the conversion. This is not specifically limited in this embodiment of this application.

208. The terminal establishes an observation equation between pose offsets of the at least two frames of point cloud data and an position offset, a yaw angle, and a system deviation, and the terminal obtains, for each frame of point cloud data, a heading angle of a vehicle that corresponds to each frame of point cloud data.

In this embodiment of this application, a laser extrinsic parameter of the laser scanning device includes the position offset and the yaw angle between the vehicle coordinate system and the laser coordinate system. In step 203 and step 204, because the system exists in the map data, there is a deviation between the second coordinates of the surface feature element and actual coordinates of the surface feature element in the vehicle coordinate system. When the pose offset of each frame of point cloud data is determined, impact of the system deviation on the second coordinates is considered. Therefore, in this step, when establishing the observation equation, the terminal also needs to consider the impact of the system deviation.

In this step, the terminal establishes the following observation equation according to the pose offset, the position offset, the yaw angle, and the system deviation of the at least two frames of point cloud data:

$$\{ \begin{matrix}{dx}_{i}^{′} = {x}_{0} \cdot cos ( {yaw}_{i} - dyaw ) - {y}_{0} \cdot sin ( {yaw}_{i} - dyaw ) + dx \\ {dy}_{i}^{′} = - {x}_{0} \cdot sin ( {yaw}_{i} - dyaw ) - {y}_{0} \cdot cos ( {yaw}_{i} - dyaw ) + dy \\ {dyaw}_{i}^{′} = dyaw\end{matrix} , \\ i = 1 , 2 , 3 , … , k$$

the system deviation being (x₀, y₀), the position offset being (dx, dy), the yaw angle being dyaw, (dx′ᵢ, dy′ᵢ) being a value of an position offset of an i^{th} frame of point cloud data in the at least two frames of point cloud data, dyaw′ᵢ being a value of a yaw angle of the i^{th} frame of point cloud data in the at least two frames of point cloud data, yawᵢ being a heading angle corresponding to the i^{th} frame of point cloud data in the at least two frames of point cloud data, and k being a total quantity of frames of the point cloud data.

It should be noted that in the laser coordinate system, the system deviation may be converted into a projection in the direction of the x axis and a projection in the direction of y axis. Because the system deviation is an error in the map data, in an actual operation, coordinates are converted into the vehicle coordinate system through the topocentric coordinate system, both the topocentric coordinate system and the vehicle coordinate system use the vehicle as the coordinate origin, but a difference thereof lies in positive directions of the x axis and the y axis, an included angle between the positive direction of the y axis of the topocentric coordinate system and the positive direction of the x axis of the vehicle coordinate system is equal to the heading angle of the vehicle.

Therefore, for each frame of point cloud data, the terminal further needs to obtain the heading angle of the vehicle that corresponds to the frame of point cloud data, and the process may be: obtaining, by the terminal, the heading angle of the vehicle that corresponds to the frame of point cloud data by using the IMU in the navigation system when the terminal obtains each frame of point cloud data.

209. The terminal calculates a value of the position offset and a value of the yaw angle in the observation equation according to the heading angle and the pose offset of each frame of point cloud data.

In this step, the terminal may substitute the pose offsets of the at least two frames of point cloud data into the observation equation, so as to calculate the value of the position offset, the value of the yaw angle, and the value of the system deviation in the observation equation according to the pose offsets of the at least two frames of point cloud data.

Theoretically, the value of the position offset, the value of the yaw angle, and the value of the system deviation in the observation equation can be determined only according to the pose offsets of the at least two frames of point cloud data. However, to reduce impact of random noise and to obtain a value of a more robust laser extrinsic parameter, in this embodiment of this application, the terminal may obtain pose offsets of n frames of point cloud data (n being a positive integer greater than 2), and a heading angle the vehicle that corresponds to each frame of point cloud data in the pose offsets of the n frames of point cloud data, substitute a pose offset of each frame of point cloud data and a corresponding heading angle into the he observation equation, and uses a least square method to calculate the value of the position offset, the value of the yaw angle, and the value of the system deviation in the observation equation. Because interference of the random noise that may exist in each frame of point cloud data is reduced by using the pose offsets of the n frames of point cloud data, an error is reduced, so that a value of the determined laser extrinsic parameter is more accurate.

It should be noted that step 208 and step 209 are actually a specific implementation of calculating, by the terminal, the value of the laser extrinsic parameter of the laser scanning device according to the pose offsets of the at least two frames of point cloud data, to calibrate the laser scanning device. However, the foregoing specific implementation may alternatively be replaced with another implementation, and the foregoing specific implementation is actually determining the value of the laser extrinsic parameter by establishing the observation equation between the pose offset and the position offset, the yaw angle, and the system deviation. In an actual operation, the terminal may further pre-establish and prestore the observation equation, or pre-write and prestore program instructions having a same function as the observation equation. The terminal directly obtains the observation equation, to determine the value of the laser extrinsic parameter; or directly obtains the program instructions, and execute the program instructions, to determine the value of the laser extrinsic parameter.

After determining the value of the laser extrinsic parameter, the terminal calibrates the laser scanning device in the vehicle by using the value of the laser extrinsic parameter, and calibrates the navigation system by using the determined value of the system deviation, so that the vehicle travels with reference to the point cloud data provided by the calibrated laser scanning device and the map data provided by the calibrated navigation system, thereby improving driving safety.

In this embodiment of this application, the terminal may obtain, based on the at least two frames of point cloud data obtained by the laser scanning device by scanning the target region, the first coordinates of the surface feature element in each frame of point cloud data, the first coordinates being the coordinates of the surface feature element in the laser coordinate system. In addition, the terminal directly determines, based on the map data of the target region of the vehicle, the second coordinates of the surface feature element in each frame of point cloud data in the vehicle coordinate system, thereby directly performing the following process according to the first coordinates and the second coordinates. A Process of manually establishing a calibration field and a manual measurement process are omitted, efficiency of determining the first coordinates and the second coordinates of is improved, thereby improving efficiency calibrating the laser scanning device. In addition, the terminal determines, for each frame of point cloud data, the pose offset of each frame of point cloud data according to the first coordinates and the second coordinates of the surface feature element; and subsequently continues to calculate the value of the laser extrinsic parameter of the laser scanning device according to the pose offsets of the at least two frames of point cloud data, to calibrate the laser scanning device in the vehicle. The terminal calculates the value of the laser extrinsic parameter of the laser scanning device according to the plurality of frames of point cloud data. Therefore, random the noise interference in each frame of point cloud data is reduced, thereby reducing an error, and improving accuracy of determining the laser extrinsic parameter.

FIG. 6 is a schematic structural diagram of an apparatus for calibrating a laser scanning device according to an embodiment of this application. Referring to FIG. 6, the apparatus includes an obtaining module 601, a first determining module 602, a second determining module 603, and a calculation module 604.

The obtaining module 601 is configured to obtain, based on at least two frames of point cloud data obtained by a laser scanning device by scanning a target region, first coordinates of a surface feature element in each frame of point cloud data, the first coordinates being coordinates of the surface feature element in a laser coordinate system.

The first determining module 602 is configured to determine, based on map data of the target region of a vehicle, second coordinates of the surface feature element in each frame of point cloud data in a vehicle coordinate system.

The second determining module 603 is configured to determine, for each frame of point cloud data, a pose offset of each frame of point cloud data according to the first coordinates and the second coordinates of the surface feature element.

The calculation module 604 is configured to calculate a value of a laser extrinsic parameter of the laser scanning device according to pose offsets of the at least two frames of point cloud data, to calibrate the laser scanning device.

In some embodiments, the obtaining module 601 includes:

a scanning unit, configured to scan the target region based on a preset scanning route by using the laser scanning device, to obtain the at least two frames of point cloud data, the target region being any region including the surface feature element; and
an extraction unit, configured to extract, for each frame of point cloud data, the first coordinates of the surface feature element in the laser coordinate system.

In some embodiments, the first determining module 602 includes:

a first obtaining unit, configured to obtain the map data of the target region from a navigation system of the vehicle, the map data including longitude and latitude coordinates and an elevation coordinate of the surface feature element in a map coordinate system; and
a first determining unit, configured to determine, for each frame of point cloud data according to the map data of the target region, the second coordinates of the surface feature element in the vehicle coordinate system.

In some embodiments, the second determining module 603 includes:

a second obtaining unit, configured to obtain an initial pose offset between the vehicle coordinate system and the laser coordinate system;

a second determining unit, configured to determine, for each frame of point cloud data, third coordinates of the surface feature element according to the initial pose offset and the second coordinates of the surface feature element, the third coordinates being coordinates of the surface feature element in the laser coordinate system; and

a third determining unit, configured to determine the pose offset of each frame of point cloud data according to the first coordinates and the third coordinates of the surface feature element.

In some embodiments, the third determining unit includes:

a calculation subunit, configured to calculate a first distance between each first dotted element and a neighboring second dotted element and a second distance between each first dotted element and a neighboring linear element according to the first coordinates and the third coordinates of the surface feature element, the first dotted element being a dotted element that is in the surface feature element and that corresponds to the first coordinates, the second dotted element being a dotted element that is in the surface feature element and that corresponds to the third coordinates, and the linear element being a linear element that is in the surface feature element and that corresponds to the third coordinates; and

a determining subunit, configured to determine the pose offset of each frame of point cloud data according to the first distance and the second distance.

In some embodiments, the laser extrinsic parameter of the laser scanning device includes an position offset and a yaw angle between the vehicle coordinate system and the laser coordinate system, and the calculation module 604 includes:

an establishment unit, configured to establish an observation equation between the pose offsets of the at least two frames of point cloud data and the position offset, the yaw angle, and a system deviation, the system deviation being a deviation between the navigation system of the vehicle and the map data;

a third obtaining unit, configured to: for each frame of point cloud data, obtaining a heading angle of the vehicle that corresponds to each frame of point cloud data; and

a calculation unit, configured to calculate a value of the position offset and a value of the yaw angle in the observation equation according to the heading angle and the pose offset of each frame of point cloud data.

In this embodiment of this application, the terminal may obtain, based on the at least two frames of point cloud data obtained by the laser scanning device by scanning the target region, the first coordinates of the surface feature element in each frame of point cloud data, the first coordinates being the coordinates of the surface feature element in the laser coordinate system. In addition, the terminal directly determines, based on the map data of the target region of the vehicle, the second coordinates of the surface feature element in each frame of point cloud data in the vehicle coordinate system, thereby directly performing the following process according to the first coordinates and the second coordinates. A Process of manually establishing a calibration field and a manual measurement process are omitted, efficiency of determining the first coordinates and the second coordinates of is improved, thereby improving efficiency calibrating the laser scanning device. In addition, the terminal determines, for each frame of point cloud data, the pose offset of each frame of point cloud data according to the first coordinates and the second coordinates of the surface feature element; and subsequently continues to calculate the value of the laser extrinsic parameter of the laser scanning device according to the pose offsets of the at least two frames of point cloud data, to calibrate the laser scanning device in the vehicle. The terminal calculates the value of the laser extrinsic parameter of the laser scanning device according to the plurality of frames of point cloud data. Therefore, random the noise interference in each frame of point cloud data is reduced, thereby reducing an error, and improving accuracy of determining the laser extrinsic parameter.

Any combination of the foregoing optional technical solutions may be used to obtain an optional embodiment of the present disclosure. Details are not described herein.

It should be noted that division of the foregoing functional modules is only described for exemplary purposes when the apparatus for calibrating a laser scanning device provided in the foregoing embodiment calibrates for a laser scanning device. In an actual application, the foregoing functions may be allocated to be accomplished by different functional modules according to requirements, that is, the internal structure of the terminal is divided into different functional modules, to accomplish all or a part of functions of the above described functions. In addition, an inventive concept of the apparatus for calibrating a laser scanning device provided in the foregoing embodiment is the same as that of the embodiment of the method for calibrating a laser scanning device. For a specific implementation process, refer to the method embodiments for details, and details are not described herein again.

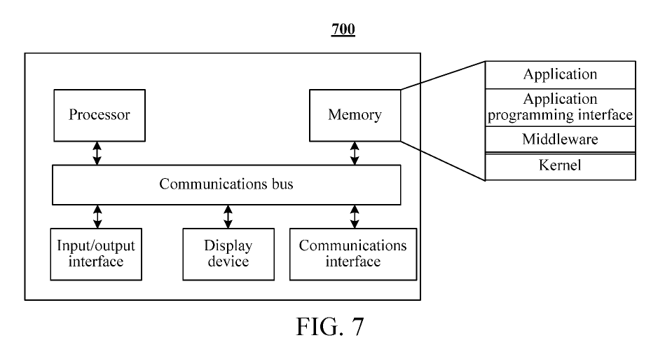

FIG. 7 is a schematic structural diagram of a computing device 700 according to an embodiment of this application. Referring to FIG. 7, the computing device 700 includes a processor and a memory, and may further include a communications interface and a communications bus, and may further include an input/output interface and a display device. The processor, the memory, the input/output interface, the display device, and the communications interface communicate with each other by using the communications bus. The memory includes a non-volatile storage medium and a main memory. The non-volatile storage medium of the computing device stores an operating system, and may further store computer readable instructions. The computer readable instructions, when executed by the processor, cause the processor to implement the method for calibrating a laser scanning device. The main memory may also store computer readable instructions. The computer readable instructions, when executed by the processor, cause the processor to perform method for calibrating a laser scanning device.

The communications bus is a circuit connecting the described elements and implements transmission between the elements. For example, the processor receives a command from another element by using the communications bus, decrypts the received command, and performs calculation or processes data according to the decrypted command. The memory may include a program module, for example, a kernel, a middleware, an application programming interface (API), and an application. The program module may include software, firmware, or hardware, or at least two thereof. The input/output interface forwards a command or data input by a user by using an input/output device (for example, a sensor, a keyboard, or a touchscreen). The display device displays various information to the user. The communications interface connects the computing device 700 to another network device, user equipment, and a network. For example, the communications interface may connect to a network in a wired or wireless manner, to connect to another external network device or user equipment. The wireless communication may include at least one of the following: wireless fidelity (Wi-Fi), Bluetooth (BT), a near field communication technology (NFC), a Global Positioning System (GPS), and cellular communication (for example, Long Term Evolution (LTE), Long Term Evolution-Advanced (LTE-A), Code Division Multiple Access (CDMA), Wideband Code Division Multiple Access (WCDMA), Universal Mobile Telecommunication System (UMTS), Wireless Broadband (WiBro), and Global System for Mobile Communications (GSM)). The wired communication may include at least one of the following: a universal serial bus (USB), a high definition multimedia interface (HDMI), a Recommended Standard 232 (RS-232), and a plain old telephone service (POTS). The network may be a telecommunication network or a communications network. The communications network may be a computer network, the Internet, the Internet of Things, or a telephone network. The computing device 700 may connect to the network by using the communications interface. A protocol used for the computing device 700 to communicate with another network device may be supported by at least one of the application, the API, the middleware, the kernel, and the communications interface.

In an exemplary embodiment, a computer readable storage medium storing a computer program is further provided, for example, a memory storing computer readable instructions. The computer readable instructions, when executed by a processor, implement the method for calibrating a laser scanning device in the foregoing embodiment. For example, the computer readable storage medium may be a read-only memory (ROM), a random access memory (RAM), a compact disc read-only memory (CD-ROM), a magnetic tape, a floppy disk, an optical data storage device, or the like.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of this application, but are not intended to limit this application. Any modification, equivalent replacement, or improvement made within the spirit and principle of this application shall fall within the protection scope of this application.

What is claimed is:

1. A method for calibrating a laser scanning device performed at a computing device having one or more processors and memory storing a plurality of programs to be executed by the one or more processors, the method comprising:
obtaining, based on at least two frames of point cloud data obtained by a laser scanning device by scanning a target region, first coordinates of a surface feature element in each frame of point cloud data, the first coordinates being coordinates of the surface feature element in a laser coordinate system;
determining, based on map data of the target region, second coordinates of the surface feature element in each frame of point cloud data in a vehicle coordinate system;
determining, for each frame of point cloud data, a pose offset of each frame of point cloud data according to the first coordinates and the second coordinates of the surface feature element; and
calculating a value of a laser extrinsic parameter of the laser scanning device according to pose offsets of the at least two frames of point cloud data, to calibrate the laser scanning device.

2. The method according to claim 1, wherein the operation of obtaining, based on at least two frames of point cloud data obtained by a laser scanning device by scanning a target region, first coordinates of a surface feature element in each frame of point cloud data further comprises:
scanning the target region based on a preset scanning route by using the laser scanning device, to obtain the at least two frames of point cloud data, the target region being any region comprising the surface feature element; and
extracting, for each frame of point cloud data, the first coordinates of the surface feature element in the laser coordinate system.

3. The method according to claim 1, wherein the operation of determining, based on map data of the target region, second coordinates of the surface feature element in each frame of point cloud data in a vehicle coordinate system further comprises:
obtaining the map data of the target region from a navigation system, the map data comprising longitude and latitude coordinates and an elevation coordinate of the surface feature element in a map coordinate system; and
determining, for each frame of point cloud data according to the map data of the target region, the second coordinates of the surface feature element in the vehicle coordinate system.

4. The method according to claim 3, wherein the operation of determining, for each frame of point cloud data according to the map data of the target region, the second coordinates of the surface feature element in the vehicle coordinate system comprises:
converting the longitude and latitude coordinates and the elevation coordinate of the surface feature element in the map coordinate system into position coordinates in a geocentric coordinate system;
converting the position coordinates of the surface feature element in the geocentric coordinate system into position coordinates in a topocentric coordinate system; and
converting the position coordinates of the surface feature element in the topocentric coordinate system into the second coordinates in the vehicle coordinate system according to an obtained heading angle of a vehicle.

5. The method according to claim 1, wherein the operation of determining, for each frame of point cloud data, a pose offset of each frame of point cloud data according to the first coordinates and the second coordinates of the surface feature element comprises:
obtaining an initial pose offset between the vehicle coordinate system and the laser coordinate system;
determining, for each frame of point cloud data, third coordinates of the surface feature element according to the initial pose offset and the second coordinates of the surface feature element, the third coordinates being coordinates of the surface feature element in the laser coordinate system; and
determining the pose offset of each frame of point cloud data according to the first coordinates and the third coordinates of the surface feature element.

6. The method according to claim 5, wherein the operation of determining, for each frame of point cloud data, third coordinates of the surface feature element according to the initial pose offset and the second coordinates of the surface feature element comprises:
for each frame of point cloud data, performing position offsetting on the second coordinates of the surface feature element according to a value of an initial position offset in the initial pose offset, and performing, according to a value of an initial yaw angle in the initial pose offset, angle offsetting on the second coordinates that have undergone the position offsetting; and
using position coordinates obtained after the position offsetting and the angle offsetting as the third coordinates of the surface feature element.

7. The method according to claim 5, wherein the operation of determining the pose offset of each frame of point cloud data according to the first coordinates and the third coordinates of the surface feature element comprises:
calculating a first distance between each first dotted element and a neighboring second dotted element and a second distance between each first dotted element and a neighboring linear element according to the first coordinates and the third coordinates of the surface feature element, the first dotted element being a dotted element that is in the surface feature element and that corresponds to the first coordinates, the second dotted element being a dotted element that is in the surface feature element and that corresponds to the third coordinates, and the linear element being a linear element that is in the surface feature element and that corresponds to the third coordinates; and
determining the pose offset of each frame of point cloud data according to the first distance and the second distance.

8. The method according to claim 1, wherein the laser extrinsic parameter of the laser scanning device comprises a position offset and a yaw angle between the vehicle coordinate system and the laser coordinate system, and the calculating a value of a laser extrinsic parameter of the laser scanning device according to pose offsets of the at least two frames of point cloud data comprises:
establishing an observation equation between the pose offsets of the at least two frames of point cloud data and the position offset, the yaw angle, and a system deviation, the system deviation being a system error in the map data;
for each frame of point cloud data, obtaining a heading angle of the vehicle that corresponds to each frame of point cloud data; and
calculating a value of the position offset and a value of the yaw angle in the observation equation according to the heading angle and the pose offset of each frame of point cloud data.

9. A computing device for calibrating a laser scanning device, comprising memory, one or more processors, and a plurality of computer readable instructions stored in the memory that, when executed by the one or more processors, cause the computing device to perform a plurality of operations including:
obtaining, based on at least two frames of point cloud data obtained by a laser scanning device by scanning a target region, first coordinates of a surface feature element in each frame of point cloud data, the first coordinates being coordinates of the surface feature element in a laser coordinate system;
determining, based on map data of the target region, second coordinates of the surface feature element in each frame of point cloud data in a vehicle coordinate system;
determining, for each frame of point cloud data, a pose offset of each frame of point cloud data according to the first coordinates and the second coordinates of the surface feature element; and
calculating a value of a laser extrinsic parameter of the laser scanning device according to pose offsets of the at least two frames of point cloud data, to calibrate the laser scanning device.

10. The computing device according to claim 9, wherein the operation of obtaining, based on at least two frames of point cloud data obtained by a laser scanning device by scanning a target region, first coordinates of a surface feature element in each frame of point cloud data further comprises:
scanning the target region based on a preset scanning route by using the laser scanning device, to obtain the at least two frames of point cloud data, the target region being any region comprising the surface feature element; and
extracting, for each frame of point cloud data, the first coordinates of the surface feature element in the laser coordinate system.

11. The computing device according to claim 9, wherein the operation of determining, based on map data of the target region, second coordinates of the surface feature element in each frame of point cloud data in a vehicle coordinate system further comprises:
obtaining the map data of the target region from a navigation system, the map data comprising longitude and latitude coordinates and an elevation coordinate of the surface feature element in a map coordinate system; and
determining, for each frame of point cloud data according to the map data of the target region, the second coordinates of the surface feature element in the vehicle coordinate system.

12. The computing device according to claim 11, wherein the operation of determining, for each frame of point cloud data according to the map data of the target region, the second coordinates of the surface feature element in the vehicle coordinate system comprises:
converting the longitude and latitude coordinates and the elevation coordinate of the surface feature element in the map coordinate system into position coordinates in a geocentric coordinate system;
converting the position coordinates of the surface feature element in the geocentric coordinate system into position coordinates in a topocentric coordinate system; and
converting the position coordinates of the surface feature element in the topocentric coordinate system into the second coordinates in the vehicle coordinate system according to an obtained heading angle of a vehicle.

13. The computing device according to claim 9, wherein the operation of determining, for each frame of point cloud data, a pose offset of each frame of point cloud data according to the first coordinates and the second coordinates of the surface feature element comprises:
obtaining an initial pose offset between the vehicle coordinate system and the laser coordinate system;
determining, for each frame of point cloud data, third coordinates of the surface feature element according to the initial pose offset and the second coordinates of the surface feature element, the third coordinates being coordinates of the surface feature element in the laser coordinate system; and
determining the pose offset of each frame of point cloud data according to the first coordinates and the third coordinates of the surface feature element.

14. The computing device according to claim 13, wherein the operation of determining, for each frame of point cloud data, third coordinates of the surface feature element according to the initial pose offset and the second coordinates of the surface feature element comprises:
for each frame of point cloud data, performing position offsetting on the second coordinates of the surface feature element according to a value of an initial position offset in the initial pose offset, and performing, according to a value of an initial yaw angle in the initial pose offset, angle offsetting on the second coordinates that have undergone the position offsetting; and
using position coordinates obtained after the position offsetting and the angle offsetting as the third coordinates of the surface feature element.

15. The computing device according to claim 13, wherein the operation of determining the pose offset of each frame of point cloud data according to the first coordinates and the third coordinates of the surface feature element comprises:
calculating a first distance between each first dotted element and a neighboring second dotted element and a second distance between each first dotted element and a neighboring linear element according to the first coordinates and the third coordinates of the surface feature element, the first dotted element being a dotted element that is in the surface feature element and that corresponds to the first coordinates, the second dotted element being a dotted element that is in the surface feature element and that corresponds to the third coordinates, and the linear element being a linear element that is in the surface feature element and that corresponds to the third coordinates; and
determining the pose offset of each frame of point cloud data according to the first distance and the second distance.

16. The computing device according to claim 9, wherein the laser extrinsic parameter of the laser scanning device comprises a position offset and a yaw angle between the vehicle coordinate system and the laser coordinate system, and the calculating a value of a laser extrinsic parameter of the laser scanning device according to pose offsets of the at least two frames of point cloud data comprises:
establishing an observation equation between the pose offsets of the at least two frames of point cloud data and the position offset, the yaw angle, and a system deviation, the system deviation being a system error in the map data;
for each frame of point cloud data, obtaining a heading angle of the vehicle that corresponds to each frame of point cloud data; and
calculating a value of the position offset and a value of the yaw angle in the observation equation according to the heading angle and the pose offset of each frame of point cloud data.

17. A non-transitory computer readable storage medium storing a plurality of instructions for calibrating a laser scanning device in connection with a computing device having one or more processors, wherein the plurality of instructions, when executed by the one or more processors, cause the computing device to perform a plurality of operations including:
obtaining, based on at least two frames of point cloud data obtained by a laser scanning device by scanning a target region, first coordinates of a surface feature element in each frame of point cloud data, the first coordinates being coordinates of the surface feature element in a laser coordinate system;
determining, based on map data of the target region, second coordinates of the surface feature element in each frame of point cloud data in a vehicle coordinate system;
determining, for each frame of point cloud data, a pose offset of each frame of point cloud data according to the first coordinates and the second coordinates of the surface feature element; and
calculating a value of a laser extrinsic parameter of the laser scanning device according to pose offsets of the at least two frames of point cloud data, to calibrate the laser scanning device.

18. The non-transitory computer readable storage medium according to claim 17, wherein the operation of obtaining, based on at least two frames of point cloud data obtained by a laser scanning device by scanning a target region, first coordinates of a surface feature element in each frame of point cloud data further comprises:
scanning the target region based on a preset scanning route by using the laser scanning device, to obtain the at least two frames of point cloud data, the target region being any region comprising the surface feature element; and
extracting, for each frame of point cloud data, the first coordinates of the surface feature element in the laser coordinate system.

19. The non-transitory computer readable storage medium according to claim 17, wherein the operation of determining, based on map data of the target region, second coordinates of the surface feature element in each frame of point cloud data in a vehicle coordinate system further comprises:
obtaining the map data of the target region from a navigation system, the map data comprising longitude and latitude coordinates and an elevation coordinate of the surface feature element in a map coordinate system; and
determining, for each frame of point cloud data according to the map data of the target region, the second coordinates of the surface feature element in the vehicle coordinate system.

20. The non-transitory computer readable storage medium according to claim 17, wherein the laser extrinsic parameter of the laser scanning device comprises a position offset and a yaw angle between the vehicle coordinate system and the laser coordinate system, and the calculating a value of a laser extrinsic parameter of the laser scanning device according to pose offsets of the at least two frames of point cloud data comprises:
establishing an observation equation between the pose offsets of the at least two frames of point cloud data and the position offset, the yaw angle, and a system deviation, the system deviation being a system error in the map data;
for each frame of point cloud data, obtaining a heading angle of the vehicle that corresponds to each frame of point cloud data; and
calculating a value of the position offset and a value of the yaw angle in the observation equation according to the heading angle and the pose offset of each frame of point cloud data.
